(19) United States
(12) Patent Application Publication
(10) Pub. No.: US 2023/0194869 A1
(43) Pub. Date: Jun. 22, 2023

(54) BACKLIGHT COMPENSATION FOR BRIGHTNESS DROP OFF

(71) Applicant: META PLATFORMS TECHNOLOGIES, LLC, Menlo Park, CA (US)

(72) Inventor: Agnes Lee, Saratoga, CA (US)

(21) Appl. No.: 17/556,938

(22) Filed: Dec. 20, 2021

(51) Int. Cl. G02B 27/01; G02F 1/1335

(52) U.S. Cl. CPC G02B 27/0172; G02F 1/133607; G02F 1/133524; G02B 27/0179; G02B 2027/0178; G02B 2027/0187

(57) ABSTRACT

A display includes pixels arranged across a display area and a backlight unit (BLU) that directs light to the pixels. The BLU includes a light source that emits light and a planar waveguide that receives the light. The planar waveguide includes diffusion structures that direct light out of the waveguide and toward the pixels. A density of the diffusion structures at a first area (e.g., a periphery area) of the planar waveguide is higher than a density of the diffusion structures at a second area (e.g., a center area) of the planar waveguide. The second area is closer to the center of the planar waveguide than the first area. This results in an intensity of light emitted from the first area being higher than an intensity of light emitted from the second area. Thus, a user may observe an image with uniform brightness, even if the viewing angle is large.

### BACKGROUND

The present disclosure relates to display devices, and specifically, to a display device with a backlight unit that emits light with greater intensity at a first area compared to a second area, where the second area is closer to the center of the display area than the first area.

Certain types of display devices have limited viewing angles. For example, certain types of display devices suffer from a decrease in brightness or a shift in color as the viewing angle increases. Moreover, as the size of a display device increases, or as the viewing distance of a display device decreases, the difference in viewing angle at which a person views different portions of the display device increases. That is, as the size of the display device increases, the angle at which a person views a pixel located near the edge of the display device compared to the angle at which the person views a pixel located near the center of the display device increases. Similarly, as the viewing distance of the display device decreases, the angle at which a person views a pixel located near the edge of the display device compared to the angle at which the person views a pixel located near the center of the display device increases. This may result in a reduction in quality of the images observed by the viewer.

### SUMMARY

Embodiments relate to a display device with a backlight unit that emits light with greater intensity at a first area compared to a second area, where the second area is closer to the center of the display area than the first area. The display device includes pixels arranged across a display area of the display device and a backlight unit (BLU) that directs light to the pixels. The BLU includes one or more light sources that emit light and includes a planar waveguide optically coupled to receive light emitted from the one or more light sources. The planar waveguide includes a first surface facing the pixels, a second surface facing away from the pixels, and diffusion structures on the first surface or the second surface. A density of the diffusion structures at a first area (e.g., a surrounding or periphery area) of the planar waveguide is higher than a density of the diffusion structures at a second area (e.g., a center area) of the planar waveguide. The second area is closer to the center of the planar waveguide than the first area. This results in an intensity of light emitted from the first area being higher than an intensity of light emitted from the second area.

In some embodiments, a chief ray angle (CRA) of light emitted from the first area and received by an eye of a user aligned with the center of the planar waveguide is larger than a CRA of light emitted from the second area and received by the eye.

In some embodiments, densities of the diffusion structures on the first surface or the second surface are tuned based on CRAs of light emitted from the display area and received by an eye of a user aligned with the center of the planar waveguide.

In some embodiments, an eye of a user receives a first percentage of light emitted from the first area and a second percentage of light emitted from the second area, and the first percentage is less than the second percentage.

In some embodiments, an eye of a user aligned with the center of the planar waveguide receives a same intensity of light from the first area as from the second area.

In some embodiments, densities of the diffusion structures on the first surface or the second surface increases with distance from the center of the planar waveguide.

In some embodiments, the diffusion structures have hemispherical shapes.

In some embodiments, the display device is part of a head mounted display (HMD) configured to be worn on a user's head. The HMD may also comprise a body and a strap configured to secure the body to the user's head. The display device may be contained in the body of the HMD.

In some embodiments, the display device is a liquid crystal display (LCD) device.

Other aspects include components, devices, systems, improvements, methods, processes, applications, computer readable mediums, and other technologies related to any of the above.

### BRIEF DESCRIPTION OF THE DRAWINGS

FIG. 1A is a perspective view of a headset implemented as an eyewear device, in accordance with one or more embodiments.

FIG. 1B is a perspective view of a headset implemented as a head-mounted display, in accordance with one or more embodiments.

FIG. 1C is a cross section of the front rigid body of the head-mounted display shown in FIG. 1B.

FIG. 2A illustrates a block diagram of an electronic display environment, in accordance with one or more embodiments.

FIG. 2B illustrates a perspective diagram of the elements of a display device, in accordance with one or more embodiments.

FIG. 2C illustrates an example display device with a two-dimensional array of illumination elements or LC-based pixels, in accordance with one or more embodiments.

FIG. 3 is a cross sectional view of a backlight unit, in accordance with one or more embodiments.

FIG. 4A is a block diagram illustrating the light output of a pixel of a display device, in accordance with one or more embodiments.

FIG. 4B is a plot of an intensity distribution for a pixel, in accordance with one or more embodiments.

FIG. 5 illustrates cross sectional view of another display device, in accordance with one or more embodiments.

FIG. 6 is a plot of the chief ray angle for various pixel positions on a display device, in accordance with one or more embodiments.

FIG. 7A illustrates a cross sectional view of a display device that emits less light at the peripheries than the center, in accordance with one or more embodiments.

FIGS. 7B and 7C illustrate display intensity plots for the display device of FIG. 7A, in accordance with one or more embodiments.

FIG. 8A illustrates a cross sectional view of a display device that emits more light at the peripheries than the center, in accordance with one or more embodiments.

FIGS. 8B and 8C illustrate display intensity plots for the display device of FIG. 8A, in accordance with one or more embodiments.

FIGS. 9A and 9B illustrate another backlight unit, in accordance with one or more embodiments.

FIG. 10 is another plot of an intensity distribution for a pixel, in accordance with one or more embodiments.

FIG. 11 illustrates an example normalized plot of light intensity for regions of a display surface of a display device, in accordance with one or more embodiments.

FIG. 12 illustrates a method for determining how to dim a display panel.

FIG. 13 is a flow chart illustrating a method, in accordance with one or more embodiments.

FIG. 14 is a system that includes a headset, in accordance with one or more embodiments.

The figures depict various embodiments of the present disclosure for purposes of illustration only. One skilled in the art will readily recognize from the following discussion that alternative embodiments of the structures and methods illustrated herein may be employed without departing from the principles of the disclosure described herein.

### DETAILED DESCRIPTION

In the following description of embodiments, numerous specific details are set forth in order to provide more thorough understanding. However, note that the embodiments may be practiced without one or more of these specific details. In other instances, features have not been described in detail to avoid unnecessarily complicating the description.

Embodiments relate to a display device with a backlight unit that emits light with greater intensity at a first area compared to a second area, where the second area is closer to the center of the display area than the first area. This results in a viewing user viewing a more uniform image.

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to create content in an artificial reality or are otherwise used in an artificial reality. The artificial reality system that provides the artificial reality content may be implemented on various platforms, including a wearable device (e.g., headset) coupled to a host computer system, a standalone wearable device (e.g., headset), a mobile device or computing system, or any other hardware platform capable of providing artificial reality content to one or more viewers.

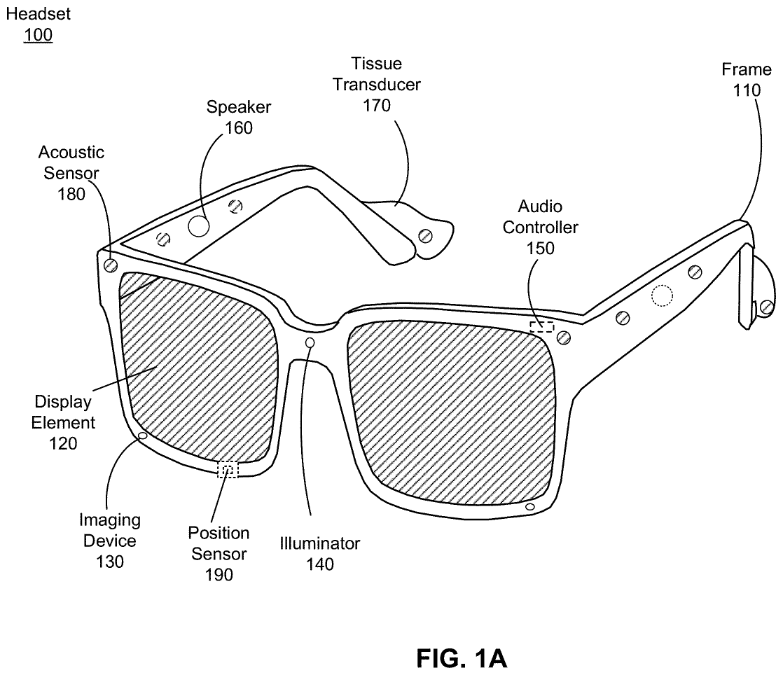

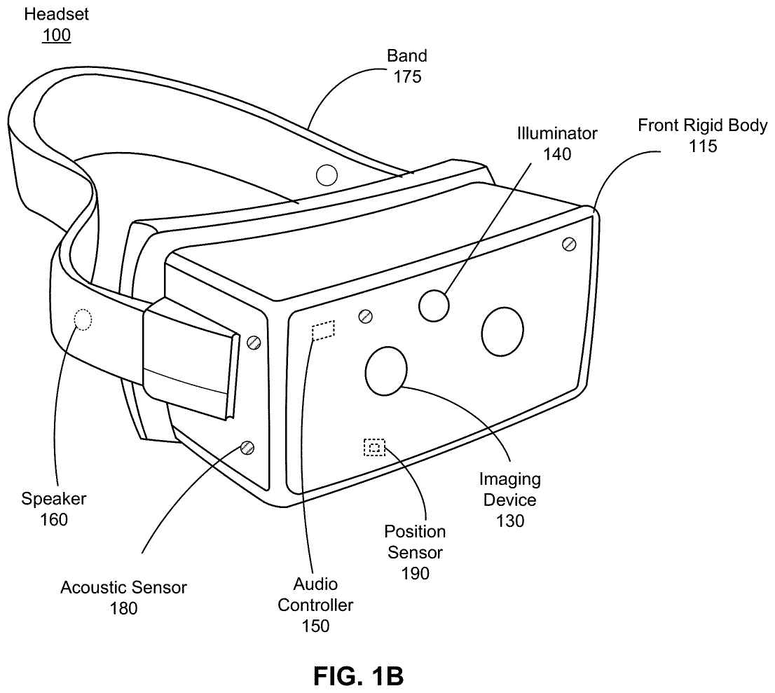

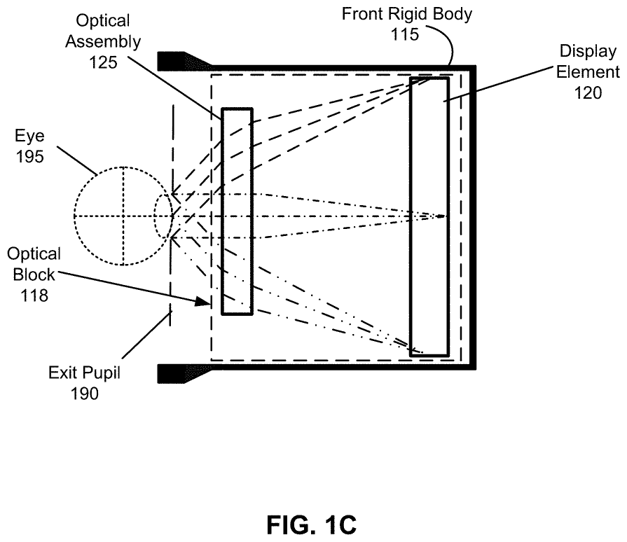

FIG. 1A is a perspective view of a headset 100 implemented as an eyewear device, in accordance with one or more embodiments. In some embodiments, the eyewear device is a near eye display (NED). In general, the headset 100 may be worn on the face of a user such that content (e.g., media content) is presented using a display assembly and/or an audio system. However, the headset 100 may also be used such that media content is presented to a user in a different manner. Examples of media content presented by the headset 100 include one or more images, video, audio, or some combination thereof. The headset 100 includes a frame, and may include, among other components, a display assembly including one or more display elements 120, a depth camera assembly (DCA), an audio system, and a position sensor 190. While FIG. 1A illustrates the components of the headset 100 in example locations on the headset 100, the components may be located elsewhere on the headset 100, on a peripheral device paired with the headset 100, or some combination thereof. Similarly, there may be more or fewer components on the headset 100 than what is shown in FIG. 1A.

The frame 110 holds the other components of the headset 100. The frame 110 includes a front part that holds the one or more display elements 120 and end pieces (e.g., temples) to attach to a head of the user. The front part of the frame 110 bridges the top of a nose of the user. The length of the end pieces may be adjustable (e.g., adjustable temple length) to fit different users. The end pieces may also include a portion that curls behind the ear of the user (e.g., temple tip, earpiece).

The one or more display elements 120 provide light to a user wearing the headset 100. As illustrated the headset includes a display element 120 for each eye of a user. In some embodiments, a display element 120 generates image light that is provided to an eyebox of the headset 100. The eyebox is a location in space that an eye of user occupies while wearing the headset 100. For example, a display element 120 may be a waveguide display. A waveguide display includes a light source (e.g., a two-dimensional source, one or more line sources, one or more point sources, etc.) and one or more waveguides. Light from the light source is in-coupled into the one or more waveguides which outputs the light in a manner such that there is pupil replication in an eyebox of the headset 100. In-coupling and/or outcoupling of light from the one or more waveguides may be done using one or more diffraction gratings. In some embodiments, the waveguide display includes a scanning element (e.g., waveguide, mirror, etc.) that scans light from the light source as it is in-coupled into the one or more waveguides. Note that in some embodiments, one or both of the display elements 120 are opaque and do not transmit light from a local area around the headset 100. The local area is the area surrounding the headset 100. For example, the local area may be a room that a user wearing the headset 100 is inside, or the user wearing the headset 100 may be outside and the local area is an outside area. In this context, the headset 100 generates VR content. Alternatively, in some embodiments, one or both of the display elements 120 are at least partially transparent, such that light from the local area may be combined with light from the one or more display elements to produce AR and/or MR content.

In some embodiments, a display element 120 does not generate image light, and instead is a lens that transmits light from the local area to the eyebox. For example, one or both of the display elements 120 may be a lens without correction (non-prescription) or a prescription lens (e.g., single vision, bifocal and trifocal, or progressive) to help correct for defects in a user's eyesight. In some embodiments, the display element 120 may be polarized and/or tinted to protect the user's eyes from the sun.

In some embodiments, the display element 120 may include an additional optics block (not shown). The optics block may include one or more optical elements (e.g., lens, Fresnel lens, etc.) that direct light from the display element 120 to the eyebox. The optics block may, e.g., correct for aberrations in some or all of the image content, magnify some or all of the image, or some combination thereof.

The DCA determines depth information for a portion of a local area surrounding the headset 100. The DCA includes one or more imaging devices 130 and a DCA controller (not shown in FIG. 1A), and may also include an illuminator 140. In some embodiments, the illuminator 140 illuminates a portion of the local area with light. The light may be, e.g., structured light (e.g., dot pattern, bars, etc.) in the infrared (IR), IR flash for time-of-flight, etc. In some embodiments, the one or more imaging devices 130 capture images of the portion of the local area that include the light from the illuminator 140. As illustrated, FIG. 1A shows a single illuminator 140 and two imaging devices 130. In alternate embodiments, there is no illuminator 140 and at least two imaging devices 130.

The DCA controller computes depth information for the portion of the local area using the captured images and one or more depth determination techniques. The depth determination technique may be, e.g., direct time-of-flight (ToF) depth sensing, indirect ToF depth sensing, structured light, passive stereo analysis, active stereo analysis (uses texture added to the scene by light from the illuminator 140), some other technique to determine depth of a scene, or some combination thereof.

The DCA may include an eye tracking unit that determines eye tracking information. The eye tracking information may comprise information about a position and an orientation of one or both eyes (within their respective eye-boxes). The eye tracking unit may include one or more cameras. The eye tracking unit estimates an angular orientation of one or both eyes based on images captures of one or both eyes by the one or more cameras. In some embodiments, the eye tracking unit may also include one or more illuminators that illuminate one or both eyes with an illumination pattern (e.g., structured light, glints, etc.). The eye tracking unit may use the illumination pattern in the captured images to determine the eye tracking information. The headset 100 may prompt the user to opt in to allow operation of the eye tracking unit. For example, by opting in the headset 100 may detect, store, images of the user's any or eye tracking information of the user.

The audio system provides audio content. The audio system includes a transducer array, a sensor array, and an audio controller 150. However, in other embodiments, the audio system may include different and/or additional components. Similarly, in some cases, functionality described with reference to the components of the audio system can be distributed among the components in a different manner than is described here. For example, some or all of the functions of the controller may be performed by a remote server.

The transducer array presents sound to user. The transducer array includes a plurality of transducers. A transducer may be a speaker 160 or a tissue transducer 170 (e.g., a bone conduction transducer or a cartilage conduction transducer). Although the speakers 160 are shown exterior to the frame 110, the speakers 160 may be enclosed in the frame 110. In some embodiments, instead of individual speakers for each ear, the headset 100 includes a speaker array comprising multiple speakers integrated into the frame 110 to improve directionality of presented audio content. The tissue transducer 170 couples to the head of the user and directly vibrates tissue (e.g., bone or cartilage) of the user to generate sound. The number and/or locations of transducers may be different from what is shown in FIG. 1A.

The sensor array detects sounds within the local area of the headset 100. The sensor array includes a plurality of acoustic sensors 180. An acoustic sensor 180 captures sounds emitted from one or more sound sources in the local area (e.g., a room). Each acoustic sensor is configured to detect sound and convert the detected sound into an electronic format (analog or digital). The acoustic sensors 180 may be acoustic wave sensors, microphones, sound transducers, or similar sensors that are suitable for detecting sounds.

In some embodiments, one or more acoustic sensors 180 may be placed in an ear canal of each ear (e.g., acting as binaural microphones). In some embodiments, the acoustic sensors 180 may be placed on an exterior surface of the headset 100, placed on an interior surface of the headset 100, separate from the headset 100 (e.g., part of some other device), or some combination thereof. The number and/or locations of acoustic sensors 180 may be different from what is shown in FIG. 1A. For example, the number of acoustic detection locations may be increased to increase the amount of audio information collected and the sensitivity and/or accuracy of the information. The acoustic detection locations may be oriented such that the microphone is able to detect sounds in a wide range of directions surrounding the user wearing the headset 100.

The audio controller 150 processes information from the sensor array that describes sounds detected by the sensor array. The audio controller 150 may comprise a processor and a computer-readable storage medium. The audio controller 150 may be configured to generate direction of arrival (DOA) estimates, generate acoustic transfer functions (e.g., array transfer functions and/or head-related transfer functions), track the location of sound sources, form beams in the direction of sound sources, classify sound sources, generate sound filters for the speakers 160, or some combination thereof.

The position sensor 190 generates one or more measurement signals in response to motion of the headset 100. The position sensor 190 may be located on a portion of the frame 110 of the headset 100. The position sensor 190 may include an inertial measurement unit (IMU). Examples of position sensor 190 include: one or more accelerometers, one or more gyroscopes, one or more magnetometers, another suitable type of sensor that detects motion, a type of sensor used for error correction of the IMU, or some combination thereof. The position sensor 190 may be located external to the IMU, internal to the IMU, or some combination thereof.

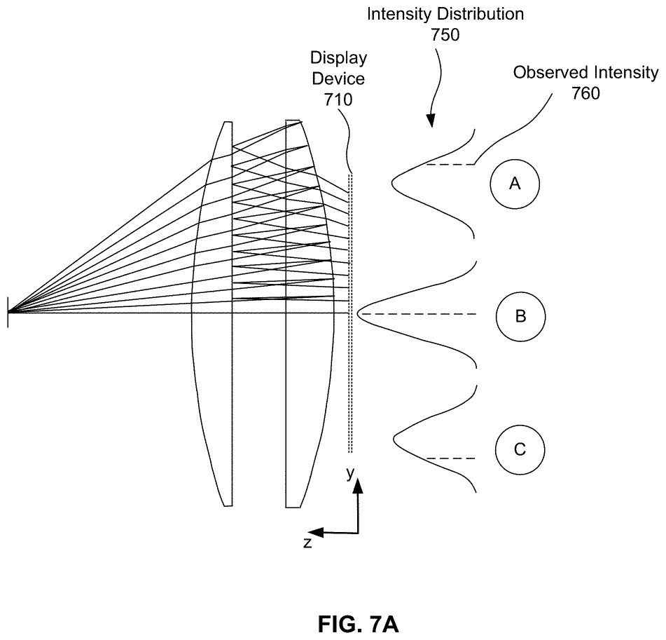

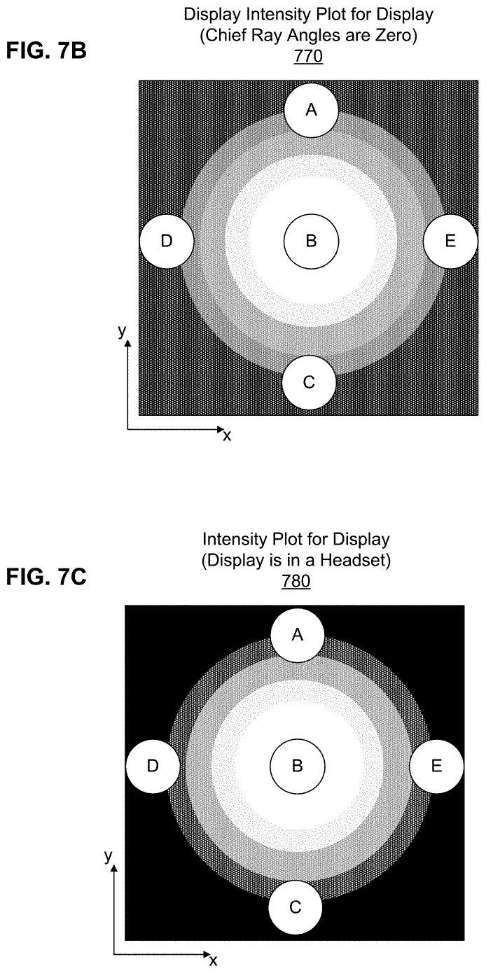

In some embodiments, the headset 100 may provide for simultaneous localization and mapping (SLAM) for a position of the headset 100 and updating of a model of the local area. For example, the headset 100 may include a passive camera assembly (PCA) that generates color image data. The PCA may include one or more RGB cameras that capture images of some or all of the local area. In some embodiments, some or all of the imaging devices 130 of the DCA may also function as the PCA. The images captured by the PCA and the depth information determined by the DCA may be used to determine parameters of the local area, generate a model of the local area, update a model of the local area, or some combination thereof. Furthermore, the position sensor 190 tracks the position (e.g., location and pose) of the headset 100 within the room. Additional details regarding the components of the headset 100 are discussed below with reference to FIG. 7.

FIG. 1B is a perspective view of a headset 105 implemented as a head mounted display (HMD), in accordance with one or more embodiments. In embodiments that describe an AR system and/or a MR system, portions of a front side of the HMD are at least partially transparent in the visible band (˜380 nm to 750 nm), and portions of the HMD that are between the front side of the HMD and an eye of the user are at least partially transparent (e.g., a partially transparent electronic display). The HMD includes a front rigid body 115 and a band 175 (also referred to as a strap). The band 175 is configured to secure the body 115 to a user's head. The headset 105 includes many of the same components described above with reference to FIG. 1A but modified to integrate with the HMD form factor. For example, the HMD includes a display assembly, a DCA, an audio system, and a position sensor 190. FIG. 1B shows the illuminator 140, a plurality of the speakers 160, a plurality of the imaging devices 130, a plurality of acoustic sensors 180, and the position sensor 190. The speakers 160 may be located in various locations, such as coupled to the band 175 (as shown), coupled to front rigid body 115, or may be configured to be inserted within the ear canal of a user.

FIG. 1C is a cross section of the front rigid body 115 of the head-mounted display shown in FIG. 1B. As shown in FIG. 1C, the front rigid body 115 includes an optical block 118 that provides altered image light to an exit pupil 190. The exit pupil 190 is the location of the front rigid body 115 where a user's eye 195 is positioned. For purposes of illustration, FIG. 1C shows a cross section associated with a single eye 195, but another optical block, separate from the optical block 118, provides altered image light to another eye of the user.

The optical block 118 includes a display element 120 (also referred to as a display or a display device), and the optics block 125. The display element 120 emits image light toward the optics block 125. The optics block 125 magnifies the image light, and in some embodiments, also corrects for one or more additional optical errors (e.g., distortion, astigmatism, etc.). The optics block 125 directs the image light to the exit pupil 190 for presentation to the user.

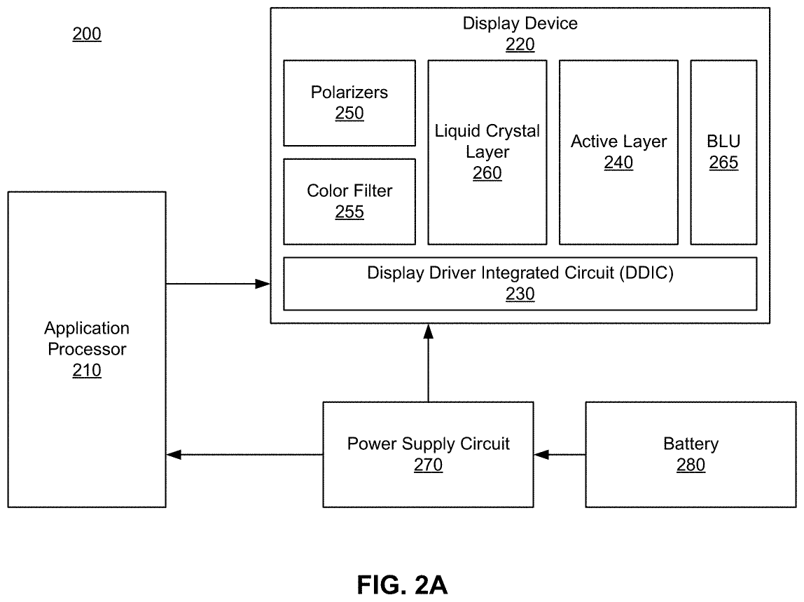

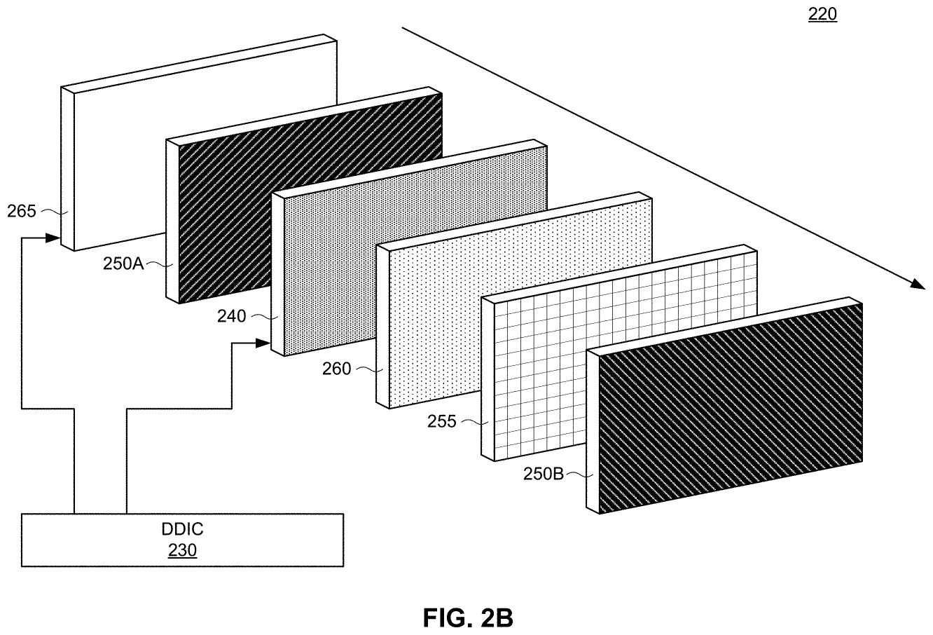

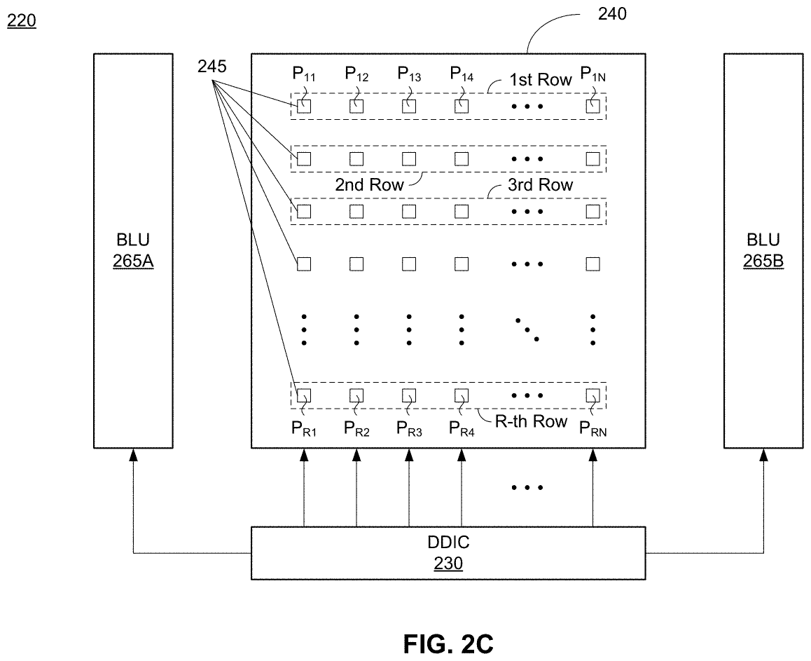

FIG. 2A illustrates a block diagram of an electronic display environment 200, in accordance with one or more embodiments. The electronic display environment 200 includes an application processor 210, and a display device 220. In some embodiments, the electronic display environment 200 additionally includes a power supply circuit 270 for providing electrical power to the application processor 210 and the display device 220. In some embodiments, the power supply circuit 270 receives electrical power from a battery 280. In other embodiments, the power supply circuit 270 receives power from an electrical outlet.

The application processor 210 generates display data for controlling the display device to display a desired image. The display data include multiple pixel data, each for controlling one pixel of the display device to emit light with a corresponding intensity. In some embodiments, each pixel data includes sub-pixel data corresponding to different colors (e.g., red, green, and blue). Moreover, in some embodiments, the application processor 210 generates display data for multiple display frames to display a video.

The display device 220 includes a display driver integrated circuit (DDIC) 230, an active layer 240, a liquid crystal (LC) layer 260, a backlight unit (BLU) 265, polarizers 250, and a color filter 255. The display device 220 may include additional elements, such as one or more additional sensors. The display device 220 may be part of the HMD 100 in FIG. 1A or FIG. 1B. That is, the display device 220 may be an embodiment of the display element 120 in FIG. 1A or FIG. 1C. FIG. 2B illustrates a perspective diagram of the elements of the display device 220, in accordance with one or more embodiments.

The DDIC 230 receives a display signal from the application processor 210 and generates control signals for controlling each pixel 245 in the active layer 240, and the BLU 265. For example, the DDIC 230 generates signals to program each of the pixels 245 in the active layer 240 according to an image signal received from the application processor 210. Moreover, the DDIC 230 generates one or more signals to control the BLU 265.

The active layer 240 includes a set of pixels 245 organized in rows and columns. For example, the active layer 240 includes N pixels (P₁₁ through P_{1N}) in the first row, N pixels (P₂₁ through P_{2N}) in the second row, N pixels (P₃₁ through P_{3N}) in the third row, and so on. Each pixel includes sub-pixels, each corresponding to a different color. For example, each pixel includes red, green, and blue sub-pixels. In addition, each pixel may include white sub-pixels. Each sub-pixel may include a thin-film-transistor (TFT) for controlling the liquid crystal in the LC layer 260. For example, the TFT of each sub-pixel is used to control an electric field within a specific area of the LC layer to control the crystal orientation of the liquid crystal within the specific area if the LC layer 260.

The LC layer 260 includes a liquid crystal which has some properties between liquids and solid crystals. In particular, the liquid crystal has molecules that may be oriented in a crystal-like way. The crystal orientation of the molecules of the liquid crystal can be controlled or changed by applying an electric field across the liquid crystal. The liquid crystal may be controlled in different way by applying the electric field in different configurations. Schemes for controlling the liquid crystal includes twisted noematic (TN), in-plane switching (IPS), plane line switching (PLS), fringe field switching (FFS), vertical alignment (VA), etc.

Each pixel 245 is controlled to provide a light output that corresponds to the display signal received from the application processor 210. For instance, in the case of an LCD panel, the active layer 240 includes an array of liquid crystal cells with a controllable polarizations state that can be modified to control an amount of light that can pass through the cell.

The BLU 265 includes light sources that are turned on at predetermined time periods to generate light that can pass through each of the liquid crystal cell to produce a picture for display by the display device. The light sources of the BLU 265 illuminate light towards the array of liquid crystal cells in the active layer 240 and the array of liquid crystal cells controls an amount and location of light passing through the active layer 240. In some embodiments, the BLU 265 includes multiple segmented backlight units, each segmented backlight unit providing light sources for a specific region or zone of the active layer 240.

The polarizers 250 filter the light outputted by the BLU 265 based on the polarization of the light. The polarizers 250 may include a back polarizer 250A and a front polarizer 250B. The back polarizer 250A filters the light outputted by the BLU 265 to provide a polarized light to the LC layer 260. The front polarizer 250B filters the light outputted by the LC layer 260. Since the light provided to the LC layer 260 is polarized by the back polarizer 250A, the LC layer controls an amount of filtering of the front polarizer 250B by adjusting the polarization of the light outputted by the back polarizer 250A.

The color filter 255 filters the light outputted by the LC layer 260 based on color. For instance, the BLU 265 generates white light and the color filter 255 filters the white light to output either red, green, or blue light. The color filter 255 may include a grid of red color filters, green color filters, and blue color filters. In some embodiments, the elements of the display device 220 are arranged in a different order. For example, the color filter may be placed between the BLU 265 and the back polarizer 250A, between the back polarizer 250A and the LC layer 260, or after the front polarizer 250B.

FIG. 2C illustrates an example display device 220 with a two-dimensional array of illumination elements or LC-based pixels 245, in accordance with one or more embodiments. In one embodiment, the display device 220 may display a plurality of frames of video content based on a global illumination where all the pixels 245 simultaneously illuminate image light for each frame. In an alternate embodiment, the display device 220 may display video content based on a segmented illumination where all pixels 245 in each segment of the display device 220 simultaneously illuminate image light for each frame of the video content. For example, each segment of the display device 220 may include at least one row of pixels 245 in the display device 220, as shown in FIG. 2C. In the illustrative case where each segment of the display device 220 for illumination includes one row of pixels 245, the segmented illumination can be referred to as a rolling illumination. For the rolling illumination, all pixels 245 in a first row of the display device 220 simultaneously illuminate image light in a first time instant; all pixels 245 in a second row of the display device 220 simultaneously illuminate image light in a second time instant consecutive to the first time instant; all pixels 245 in a third row of the display device 220 simultaneously illuminate image light in a third time instant consecutive to the second time instant, and so on. Other orders of illumination of rows and segments of the display device 220 are also supported in the present disclosure. In yet another embodiment, the display device 220 may display video content based on a controllable illumination where all pixels 245 in a portion of the display device 220 of a controllable size (not shown in FIG. 2C) simultaneously illuminate image light for each frame of the video content. The controllable portion of the display device 220 can be rectangular, square or of some other suitable shape. In some embodiments, a size of the controllable portion of the display device 220 can be a dynamic function of a frame number.

Although the above description describes a liquid crystal display device 220, other types of display devices, such as an organic light-emitting diode (OLED), may be used.

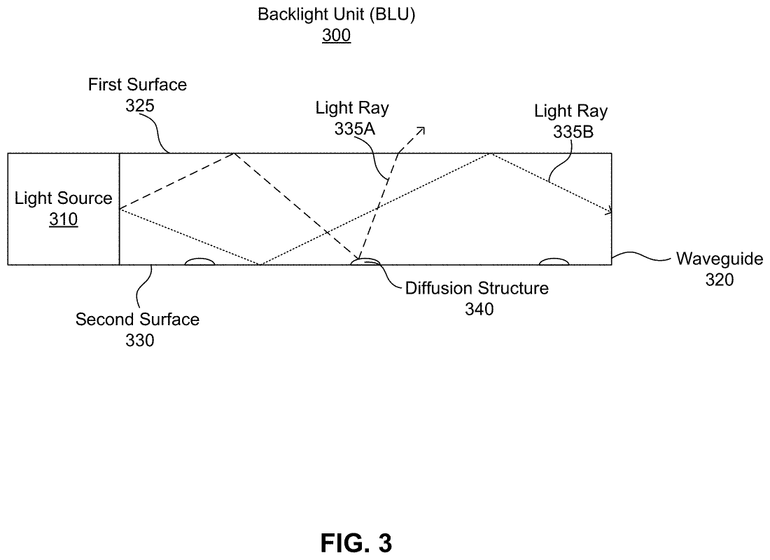

FIG. 3 is a cross sectional view of a BLU 300 (e.g., BLU 265), in accordance with some embodiments. The BLU 300 includes a light source 310 and a planar waveguide 320. In the example of FIG. 3, the BLU 300 is edge lit, meaning that the light source 310 is located along an edge of the waveguide 320. Other types of BLUs may be used though, such as a full array BLU. The light source 310 emits light that is coupled into the waveguide 320. An example light source 310 is a light-emitting diode (LED) coupled to the waveguide 320. Light beams 335A and 335B are generated by light source 310. The beams 335 propagate via total internal reflection through the waveguide 320.

The waveguide 320 includes three diffusion structures 340 on the second surface 330 that disrupt the light in the waveguide 320. The diffusion structures 340 are passive optical structures that diffuse and spread light in the waveguide 320. In the example of FIG. 3, the diffusion structures 340 protrude from the second surface inside of the waveguide. In some embodiments, one or more (or all) of the diffusion structures 340 protrude outside of and away from the waveguide. The diffusion structures 340 result in light exiting the waveguide 320 (e.g., through the first surface 325) and propagating toward pixels in the active layer 240 (not illustrated in FIG. 3). In the example of FIG. 3, light ray 335A is directed by the middle diffusion structure 340 toward the first surface 325. Ray 335A exits the waveguide 320 though the first surface 325. Example diffusion structures include dot patterns, prisms, or lenticular lenses. In some embodiments, the waveguide 320 is a flat glass substrate or plastic substrate (e.g., made of PMMA or PC), and the second surface 330 is a rough surface that spreads light from the light source 310. In the example of FIG. 3, the diffusion structures 340 have hemispherical shapes. Among other advantages, hemispherical shapes may scatter light more uniformly compared to other shapes. However, the diffusion structures 340 may have other shapes. The diffusion structures 340 may also have different sizes than those illustrated. Generally, larger structure sizes are better in efficiency but worse in uniformity. Example diameters for hemispherical structures range from few microns to few tens of microns (˜20 um). In some embodiments, the size, shape, or density of the diffusion structures is designed based on specifications for a given display device. For example, a BLU may have a larger density of diffusion structures to increase light diffusion. In another example, a BLU has larger diffusion structures to increase the brightness. Although FIG. 3 only illustrates diffusion structures 340 on the second surface 330, other surfaces, such as the first surface 325, may also include diffusion structures.

In the example of FIG. 3, the diffusion structures 340 are uniformly distributed across the second surface. However, as further described below, the density of the structures 340 may be based on the distance from the center of the waveguide 320. Additionally, the density of the structures 340 may be based on the amount of light propagating in a section of the waveguide 320. The amount of light in a section may decrease with section distance from the light source 310 (also referred to as “brightness distance”). For example, for the BLU 300 to emit a uniform distribution of light, the density of the diffusion structures 340 may increase with distance from the light source 310 (since there is less light in sections farther away from the light source, more diffusion structures may be used to create the uniform distribution). Note that the dependence of structure density with brightness distance may decrease if the BLU 300 includes multiple light sources (e.g., on both sides of the waveguide 320). If the BLU 300 includes multiple light sources, the brightness distance may refer to the distance to the closest light source or the average distance of multiple light sources.

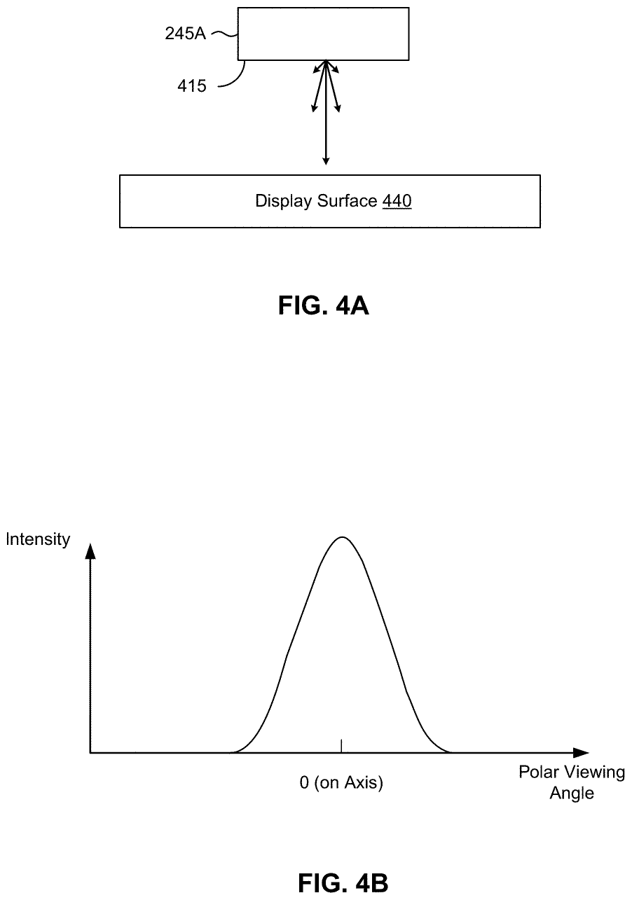

FIG. 4A is a block diagram illustrating the light output of a pixel 245 of a display device (e.g., device 220), according to some embodiments. The pixel 245A is configured to output light through a front surface 415. The front surface 415 of pixel 245 may output light with different intensities and at different angles. In the example of FIG. 4A, pixel 245A outputs light having an intensity distribution centered at a direction perpendicular to the front surface 440 (also referred to as the display area) of the display panel. This distribution may be due to the construction of the pixel or a black matrix in front of the pixel blocking portions of emitted light.

FIG. 4B is a plot of the intensity distribution (also referred to as intensity profile or light distribution) for the pixel 245A, according to some embodiments. Each pixel in a display device may have an intensity distribution like the distribution illustrated in FIG. 4B. The y-axis describes the light intensity, and the x-axis describes the polar viewing angle (e.g., along the horizontal or vertical direction of the display surface 440 of the display panel). The intensity follows a normal distribution. Thus, if a user is aligned with the pixel, they observe the highest brightness. However, if the user is misaligned with the pixel, the brightness decreases. As used herein, brightness refers to how intensely a user perceives the light. Light intensity is a physical quantity that refers to power per unit area. Example intensities include luminous intensity and radiant intensity.

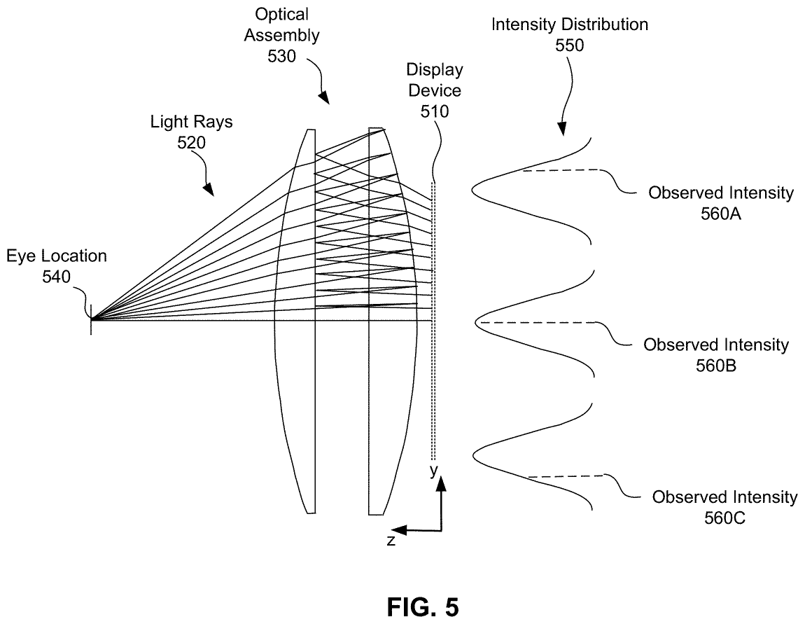

FIG. 5 illustrates cross sectional view of a display device 510 (e.g., device 220), according to some embodiments. Light rays 520 emitted from the display device 510 pass through an optical assembly 530 (e.g., optical assembly 125) and focus to a point where a user's eye is located 540. Each ray 520 is emitted from a pixel at a chief ray angle. FIG. 5 also illustrates intensity distributions 550 (e.g., like FIG. 4B) for pixels located at different locations on the display device 510. Specifically, the distributions 550 correspond to light emitted from pixels at the top, center, and bottom areas of the display device 510.

Because the user's eye is aligned with the center of the display, the chief ray angle of a light ray from a center pixel is smaller than the chief ran angle of a light ray from a top or bottom pixel. Due to such differences in the chief ray angles, the user's eye observes 560B light with peak intensity from pixels in the center of the display device 510. However, the user's eye is not aligned with pixels at the top and bottom of the display device 510. Thus, the user's eye observes 560A and 560C dimmer light (e.g., less than peak intensity) from those pixels (because the chief ray angles are larger). In some cases, the user's eye receives a greater percentage of light emitted from a center pixel (e.g., in area B) than the percentage of light emitted from a pixel farther away from the center (e.g., a top or bottom pixel). This may result in the center of the display device 510 appearing brighter than the periphery. If the user's eye is located farther away, the chief ray angles for the top and bottoms pixels may be smaller. Smaller chief ray angles may decrease the brightness differences observed by the user across the display. However, if the display is used in a headset (e.g., an HMD), increasing the distance between the user's eye and the display may be impractical or impossible.

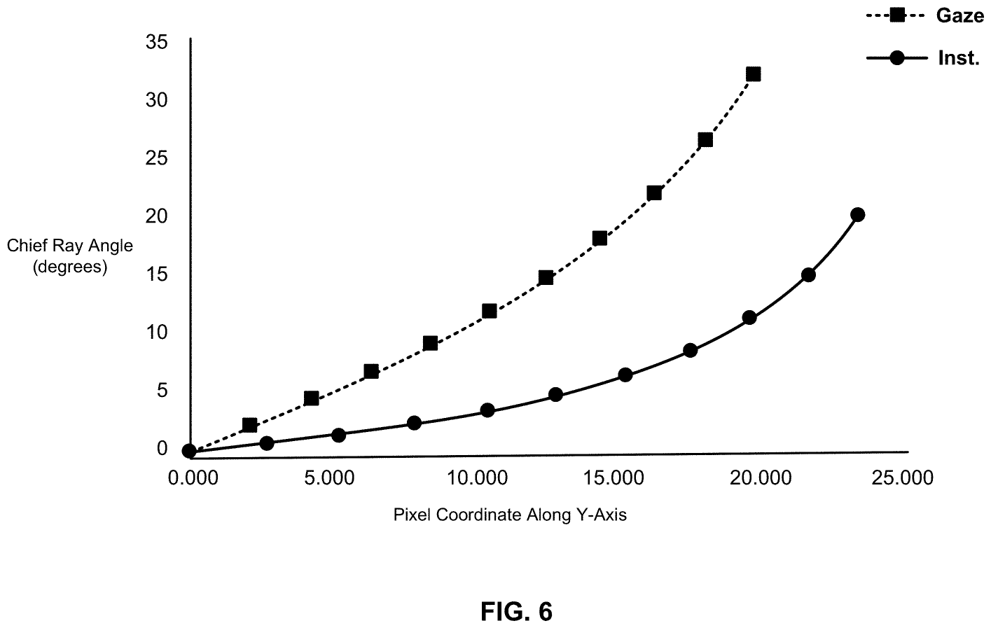

FIG. 6 is a plot of the chief ray angle for various pixel positions on a display device, according to one or more embodiments. The plot may describe chief ray angles for the display device 510 in FIG. 5. The x-axis of the plot describes pixel positions on a display panel along the y-axis (see panel coordinate system in FIG. 5). Zero on the x-axis indicates that the pixel is at the center of the display. The y-axis of the plot describes the chief ray angle for a light ray emitted from a pixel and received by the user's eye. The chief ray angle is given in degrees where an angle of zero indicates that the ray is emitted perpendicular to the pixel surface. The “Gaze” plot indicates that the user's pupil is rotated to align with the light ray entering the eye. The “Inst.” plot indicates that the user's pupil stays on axis. Thus, the light ray is observed by the user's peripheral vision. Overall, the plot illustrates that the chief ray angle increases with distance from the center of the display panel. For the “Gaze” plot, the highest chief ray angle is about thirty-three degrees (corresponding to a pixel at or near the edge of the display) and the smallest chief ray angle is zero (corresponding to a pixel at the center of the display).

Referring back to FIG. 5, the display device 510 emits the same amount of light across the display surface. This is indicated by the intensity distributions 550 having the same shape and size. Emitting light uniformly may be accomplished by tuning diffusion structures of the BLU so that the BLU uniformly emits light. For example, the diffusion structures of the BLU are even distributed across the BLU. Note that the previous example does not account for brightness distance.

That being said, some display devices emit light nonuniformly. For example, FIG. 7A illustrates a cross sectional view of a display device 710 that emits light nonuniformly. Specifically, pixels in the center of the display device 710 emit more light than pixels in the periphery. To accomplish this, diffusion structures of a BLU of the display device 710 may have higher densities near the center of the display than the peripheries or the BLU may have more light sources near the center than a corner of the display. The light differences are indicated by the intensity distribution 750 of area B being larger than the intensity distributions 750 of areas A and C. This is also illustrated in the display intensity plot 770 in FIG. 7B. The intensity plot 770 illustrates the light intensity across the display surface if the chief ray angle for each pixel is zero (e.g., the user is far enough away the chief ray angle for each pixel is effectively zero). As illustrated, area B (at the center of the display) emits light with the highest relative intensity. As distance from the center increases, the light intensity decreases. The areas of lowest intensity (e.g., areas A, C, D, and E) are at the peripheries of the display. However, if the display device 710 is used in a headset (e.g., an HMD), the chief ray angles may be nonzero, especially for pixels near the edge of the display 710. In this case, the brightness differences across the display surface may be enlarged. As illustrated in FIG. 7C, areas A, C, D, and E are much dimmer than area B. This is also indicated by the observed intensities 760 in FIG. 7A. Such large differences in brightness across the display surface may degrade image quality and user experience. Thus, display device 710 may be disadvantageous for use in a headset (e.g., an HMD).

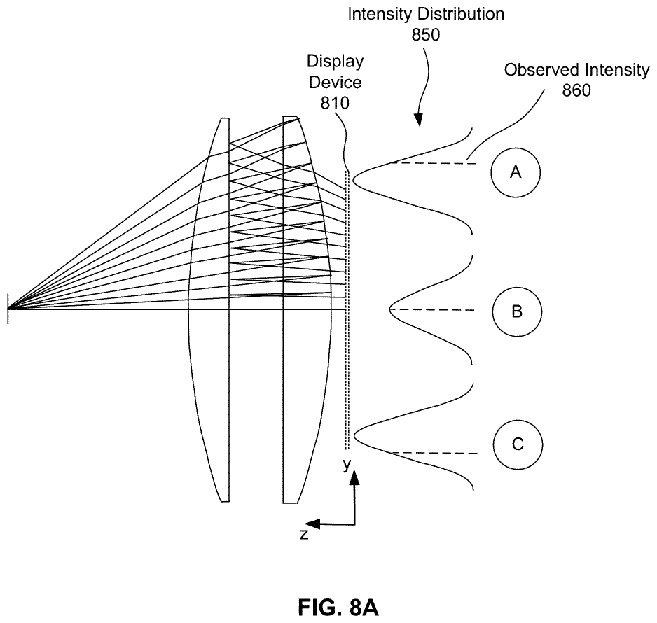

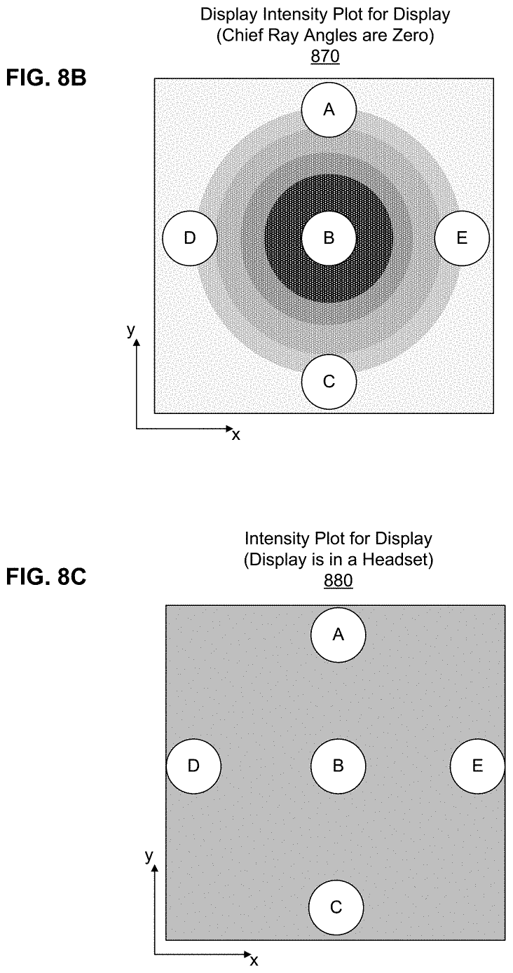

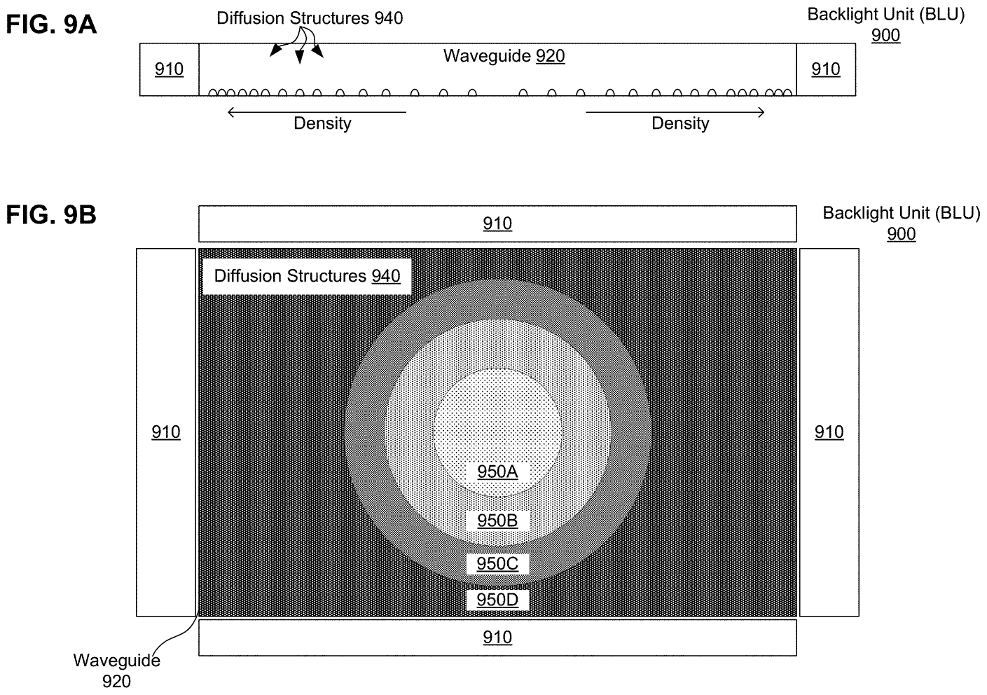

To compensate for differences in observed brightness across a display surface, a display device may be configured so that pixels in the center of the display device emit less light than pixels outside of the center (e.g., in the periphery). Said differently, pixels in the center area may have smaller intensity distributions than pixels outside of the center area. For example, FIG. 8A illustrates a cross sectional view of a display device 810 that emits more light at the peripheries than the center. More generally, the amount of emitted light increases with distance from the center. To accomplish this, diffusion structures of a BLU of the display device 810 may have smaller densities at the center than the peripheries (further described below with reference to FIGS. 9A-9B). The light differences of display 810 are indicated by the intensity distribution 850 of area B being smaller than the intensity distributions 850 of areas A and C. This is also illustrated in the display intensity plot 870 in FIG. 8B. The intensity plot 870 illustrates the light intensity across the display surface if the chief ray angle for each pixel is zero. As illustrated, areas A, C, D, and E emit light with the highest relative intensity. As distance from the center decreases, the light intensity decreases.

If the display device 810 is used in a headset (e.g., an HMD), the chief ray angles may be nonzero, especially for pixels near the edge of the display. In these embodiments, the brightness differences across the display surface may be decreased or not noticeable (e.g., assuming the eye of the user is aligned with the center of the display). As illustrated in FIG. 8C, all five areas (A, B, C, D, and E) have the same observed intensity. Said differently, by tuning the display device 810 so that the peripheries are more intense than the center of the display surface, the brightness across the display surface may be substantially uniform (or the brightness uniformity may at least be increased). This is also indicated by the observed intensities 860 in FIG. 8A, which are the same for areas A, B, and C. In some embodiments, the eye of the user receives a same intensity (e.g., within a threshold deviation) of light from each area of the display surface. For example, the user receives a same light intensity from a center pixel as an edge pixel. Thus, display device 810 may be advantageous for use in a headset (e.g., an HMD).

FIGS. 9A and 9B illustrate an example BLU 900 that may be used in display device 810, in accordance with some embodiments. FIG. 9A is a cross sectional view and FIG. 9B is a top view of BLU 900. BLU 900 includes a planar waveguide 920 (with diffusion structures 940) and light sources 910 on four sides of the waveguide 920. In the example of FIG. 9A, the diffusion structures 940 protrude inside of the waveguide. However, the diffusion structures 940 may protrude away from the waveguide. While the diffusion structures 340 in FIG. 3 are uniformly distributed across the second surface 330 of waveguide 320, the diffusion structures 940 of waveguide 920 are distributed nonuniformly. Specifically, the density of the diffusion structures 940 increases with distance from the center of the waveguide 920 (the center of the waveguide may correspond to the center of the display surface or the display device). The density may describe the number of diffusion structures 940 per unit area. Additionally, or alternatively, the density may describe the spacing between adjacent structures 940. In this case, smaller spacing indicates a higher density and larger spacing indicates a smaller density.

Referring to FIG. 9B, the waveguide 920 includes areas 950A-950D with different diffusion structure densities. Area 950A is at the center of the waveguide 920 and includes the lowest density of diffusion structures. Area 950B is outside of area 950A and includes a higher density than area 950A. Area 950C is outside of area 950B and includes a higher density than area 950B. Area 950D includes the remaining area between area 950C and the edge of waveguide 920. Area 950D includes the highest diffusion structure density. Although areas 950A-950D are concentric circular areas, other density distributions are possible. For example, the density may be characterized by a function that increases (e.g., linearly) from the center to the edges of waveguide 920.

Since diffusion structures direct light out of the waveguide 920, areas with more structures (areas with higher densities) may direct more light outside of the waveguide 920 and areas with fewer structures (areas with lower densities) may direct less light outside of the waveguide 920. This may result in regions of pixels emitting different amounts of light across the display. In the example FIGS. 9A and 9B, more light may be directed through edge pixels (e.g., pixels aligned with area 950D) than center pixels (e.g., pixels aligned with area 950A).

Note that the examples of FIGS. 9A and 9B do not account for brightness distances (e.g., the amount of light exiting the waveguide due to the diffusion structures 940 is much less than the amount of light produced by the light sources 910). If brightness distance is accounted for, then for two areas with similar or equal brightness distances, the area that is closer to the center of the waveguide 920 may have a smaller diffusion structure density and the area that is farther away from the center may have a larger diffusion structure density.

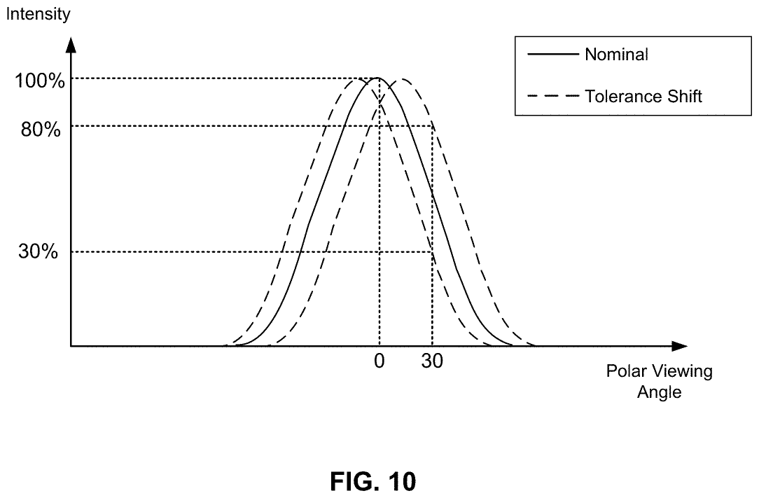

FIG. 10 is plot of the light distribution for a pixel, according to some embodiments. FIG. 10 may be used to determine how much to dim an area of the display surface so that the user observes a substantially uniform image. The y-axis of the plot describes normalized intensity, where the peak intensity has a value of 100%. The x-axis describes the polar viewing angle (e.g., along the horizontal or vertical direction of the display surface of a display panel). Like FIG. 4B, the intensity profile follows a normal distribution. FIG. 10 also indicates example manufacturing tolerances for pixels of the display. These distribution profiles are indicated with dashed lines. Thus, pixels in a display panel may have distribution profiles (e.g., normal distributions) equal to or within the tolerance profiles.

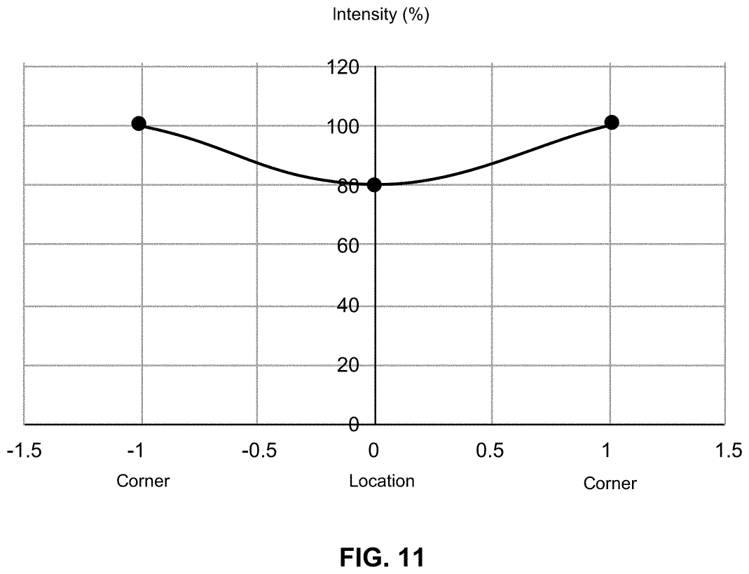

Determining how much to dim the center intensity of a display panel so that the user observes a substantially uniform brightness, may depend on the optical assembly of the headset, the intensity profiles of pixels in the display, and the chief ray angles of light beams emitted from the pixels and received by the user's eye. Thus, the plots in FIGS. 6 and 10 may be used in conjunction to determine how much to dim the center intensity. For example, referring to FIG. 6, the chief ray angle for a corner pixel is about thirty degrees. Referring now to FIG. 10, a thirty-degree viewing angle corresponds to an intensity percentage of thirty to eighty percent (considering the manufacturing tolerances). Thus, the center intensity of the display may be dimmed to eighty percent (to avoid overcompensation) so that the user observes an image with uniform brightness across the display surface (this example is further described below with reference to FIG. 11). As previously described, the dimming may be accomplished by arranging diffusion structures in the waveguide.

FIG. 11 illustrates an example normalized plot of light intensity for regions of a display surface of a display device. The y-axis indicates the intensity percentage for various areas of the display surface. The x-axis indicates the location on the display surface along a line from a first corner to a diagonally opposite second corner. The value “0” on the x-axis represents the center of the surface and values “1” and “−1” on the x-axis indicate opposite corners of the display surface. In the example of FIG. 11, the corners are normalized to have 100% intensity (both corners have the same intensity). The plot thus indicates that the center of the display is 20% dimmer than the corners (the percentage may be different in other embodiments). The intensity percentage increases as the distance from the center increases. This intensity distribution may result in the user observing an image that is uniformly bright, although uniformity of the brightness may depend on the type of the display device, the optical assembly, and the location of the user's eye relative to the display device.

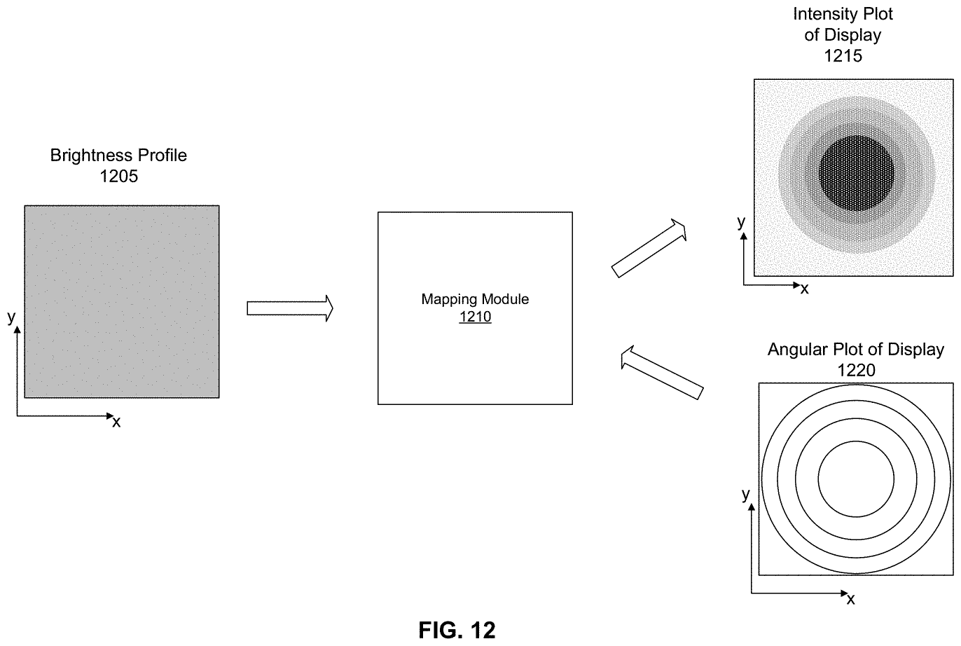

FIG. 12 illustrates a method for determining how to dim a display panel. The method uses a mapping module 1210, an angular plot of the display 1220, and a brightness profile plot 1205 to generate an intensity plot of a display 1215. The angular plot 1220 (also referred to as the display angular profile) describes the chief ray angles of light emitted by a display and observed by a user (assuming the user is vertically and horizontally aligned with the display surface). Although not indicated in FIG. 12, the angle increases with distance from the center. The brightness profile plot 1205 describes the light intensity observed by a user (e.g., see FIG. 7C or 8C). The mapping module generates a mapping function that maps each xy coordinate in 1205 to a chief ray angle on the display. As previously described, an intensity plot describes the light intensities of a display surface, assuming the chief ray angle for each pixel is zero (e.g., see FIG. 7B or 8B).

The mapping module 1210 may determine an intensity plot 1215 for a given brightness profile plot 1205 and angular plot 1220. For example, the mapping module 1210 is used to determine how much to dim areas of a display panel so that the user observes an image with substantially uniform brightness. This example is illustrated in FIG. 12. An image 1205 with a uniform brightness and an angular plot 1220 are input into the mapping module 1210. The mapping module 1210 outputs an intensity plot 1215 of the display. Thus, if a display is constructed to emit light similar to the intensity plot 1215 (e.g., the BLU of the display is tuned based on the intensity plot), the display may emit an image that has a uniform brightness. In some cases, the mapping module 1210 can be used in reverse order. For example, the mapping module 1210 determines a brightness profile plot 1205 for a given intensity plot 1215 and angular plot 1220.

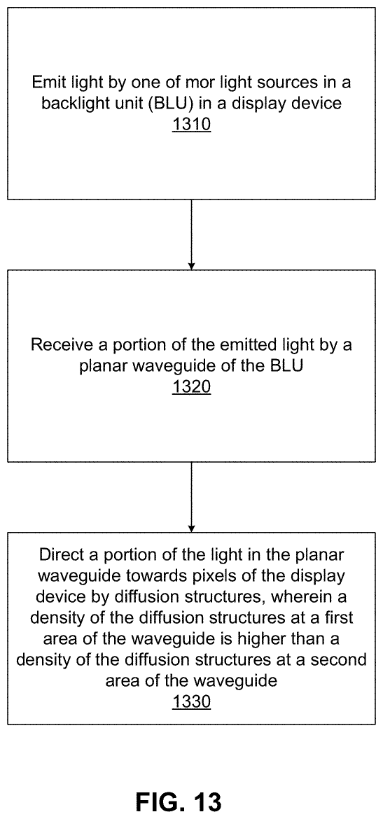

FIG. 13 is a flow chart illustrating a method for displaying, by a display device, light with a greater intensity at a first area compared to a second area, where the second area is closer to the center of the display area than the first area, according to one or more embodiments. The steps of method may be performed in different orders, and the method may include different, additional, or fewer steps.

One or more light sources of a backlight unit (BLU) in a display device emit 1310 light. A planar waveguide of the BLU receives 1320 a portion of the emitted light. The planar waveguide includes a first surface facing pixels of the display device and a second surface facing away from the pixels. Diffusion structures on the first surface or the second surface direct 1330 a portion of the light in the planar waveguide towards pixels of the display device. A density of the diffusion structures at a first area of the planar waveguide are higher than a density of the diffusion structures at a second area of the planar waveguide closer to a center of the planar waveguide. This results in an intensity of light emitted from the first area being higher than an intensity of light emitted from the second area.

Embodiments described above relate to arrangements of diffusion structures in a waveguide of a BLU so that a user observes a uniformly bright image. Said differently, the diffusion structures may be arranged so that a user's eye receives the same intensity of light (e.g., within a threshold deviation) from different pixel of the display. However, the diffusion structures may be arranged so that a user observes an image with nonuniform brightness. For example, the diffusion structures may be arranged so that an observed image is brighter at the center or at the periphery.

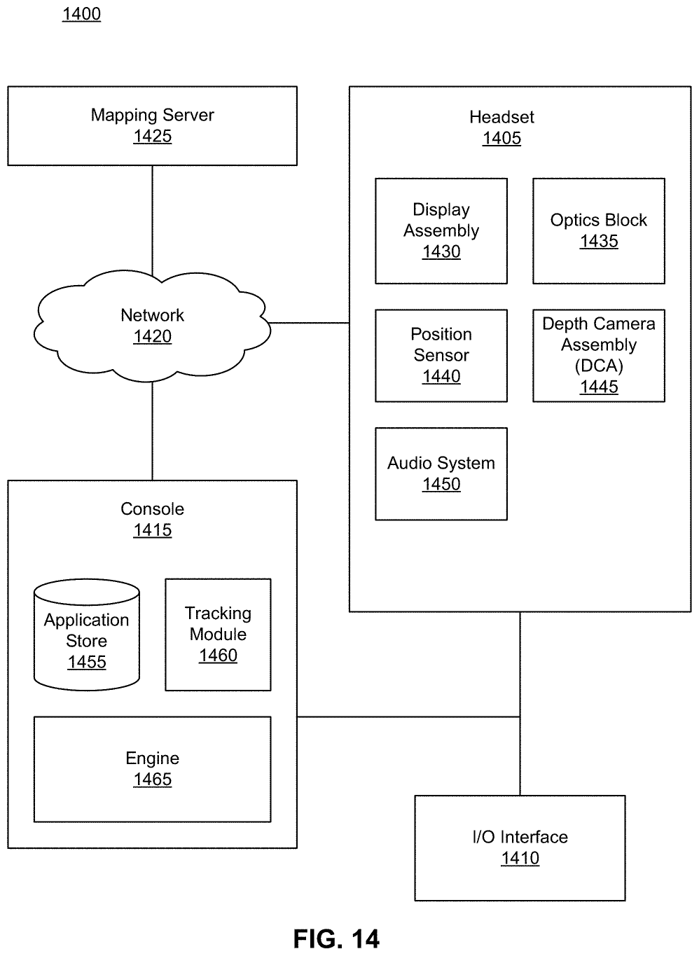

FIG. 14 is a system 1400 that includes a headset 1405, in accordance with one or more embodiments. In some embodiments, the headset 1405 may be the headset 100 of FIG. 1A or the headset 105 of FIG. 1B. The system 1400 may operate in an artificial reality environment (e.g., a virtual reality environment, an augmented reality environment, a mixed reality environment, or some combination thereof). The system 1400 shown by FIG. 14 includes the headset 1405, an input/output (I/O) interface 1410 that is coupled to a console 1415, the network 1420, and the mapping server 1425. While FIG. 14 shows an example system 1400 including one headset 1405 and one I/O interface 1410, in other embodiments any number of these components may be included in the system 1400. For example, there may be multiple headsets each having an associated I/O interface 1410, with each headset and I/O interface 1410 communicating with the console 1415. In alternative configurations, different and/or additional components may be included in the system 1400. Additionally, functionality described in conjunction with one or more of the components shown in FIG. 14 may be distributed among the components in a different manner than described in conjunction with FIG. 14 in some embodiments. For example, some or all of the functionality of the console 1415 may be provided by the headset 1405.

The headset 1405 includes the display assembly 1430, an optics block 1435 (also referred to as an optical assembly), one or more position sensors 1440, and the DCA 1445. Some embodiments of headset 1405 have different components than those described in conjunction with FIG. 14. Additionally, the functionality provided by various components described in conjunction with FIG. 14 may be differently distributed among the components of the headset 1405 in other embodiments, or be captured in separate assemblies remote from the headset 1405.

The display assembly 1430 displays content to the user in accordance with data received from the console 1415. The display assembly 1430 displays the content using one or more display elements (e.g., the display elements 120). A display element may be, e.g., an electronic display. In various embodiments, the display assembly 1430 comprises a single display element or multiple display elements (e.g., a display for each eye of a user). Examples of an electronic display include: a liquid crystal display (LCD), an organic light emitting diode (OLED) display, an active-matrix organic light-emitting diode display (AMOLED), a waveguide display, some other display, or some combination thereof. Note in some embodiments, the display element 120 may also include some or all of the functionality of the optics block 1435.

The optics block 1435 may magnify image light received from the electronic display, corrects optical errors associated with the image light, and presents the corrected image light to one or both eyeboxes of the headset 1405. In various embodiments, the optics block 1435 includes one or more optical elements. Example optical elements included in the optics block 1435 include: an aperture, a Fresnel lens, a convex lens, a concave lens, a filter, a reflecting surface, or any other suitable optical element that affects image light. Moreover, the optics block 1435 may include combinations of different optical elements. In some embodiments, one or more of the optical elements in the optics block 1435 may have one or more coatings, such as partially reflective or anti-reflective coatings.

Magnification and focusing of the image light by the optics block 1435 allows the electronic display to be physically smaller, weigh less, and consume less power than larger displays. Additionally, magnification may increase the field of view of the content presented by the electronic display. For example, the field of view of the displayed content is such that the displayed content is presented using almost all (e.g., approximately 110 degrees diagonal), and in some cases, all of the user's field of view. Additionally, in some embodiments, the amount of magnification may be adjusted by adding or removing optical elements.

In some embodiments, the optics block 1435 may be designed to correct one or more types of optical error. Examples of optical error include barrel or pincushion distortion, longitudinal chromatic aberrations, or transverse chromatic aberrations. Other types of optical errors may further include spherical aberrations, chromatic aberrations, or errors due to the lens field curvature, astigmatisms, or any other type of optical error. In some embodiments, content provided to the electronic display for display is pre-distorted, and the optics block 1435 corrects the distortion when it receives image light from the electronic display generated based on the content.

The position sensor 1440 is an electronic device that generates data indicating a position of the headset 1405. The position sensor 1440 generates one or more measurement signals in response to motion of the headset 1405. The position sensor 190 is an embodiment of the position sensor 1440. Examples of a position sensor 1440 include: one or more IMUs, one or more accelerometers, one or more gyroscopes, one or more magnetometers, another suitable type of sensor that detects motion, or some combination thereof. The position sensor 1440 may include multiple accelerometers to measure translational motion (forward/back, up/down, left/right) and multiple gyroscopes to measure rotational motion (e.g., pitch, yaw, roll). In some embodiments, an IMU rapidly samples the measurement signals and calculates the estimated position of the headset 1405 from the sampled data. For example, the IMU integrates the measurement signals received from the accelerometers over time to estimate a velocity vector and integrates the velocity vector over time to determine an estimated position of a reference point on the headset 1405. The reference point is a point that may be used to describe the position of the headset 1405. While the reference point may generally be defined as a point in space, however, in practice the reference point is defined as a point within the headset 1405.

The DCA 1445 generates depth information for a portion of the local area. The DCA includes one or more imaging devices and a DCA controller. The DCA 1445 may also include an illuminator. Operation and structure of the DCA 1445 is described above with regard to FIG. 1A.

The audio system 1450 provides audio content to a user of the headset 1405. The audio system 1450 is substantially the same as the audio system 200 describe above. The audio system 1450 may comprise one or acoustic sensors, one or more transducers, and an audio controller. The audio system 1450 may provide spatialized audio content to the user. In some embodiments, the audio system 1450 may request acoustic parameters from the mapping server 1425 over the network 1420. The acoustic parameters describe one or more acoustic properties (e.g., room impulse response, a reverberation time, a reverberation level, etc.) of the local area. The audio system 1450 may provide information describing at least a portion of the local area from e.g., the DCA 1445 and/or location information for the headset 1405 from the position sensor 1440. The audio system 1450 may generate one or more sound filters using one or more of the acoustic parameters received from the mapping server 1425, and use the sound filters to provide audio content to the user.

The I/O interface 1410 is a device that allows a user to send action requests and receive responses from the console 1415. An action request is a request to perform a particular action. For example, an action request may be an instruction to start or end capture of image or video data, or an instruction to perform a particular action within an application. The I/O interface 1410 may include one or more input devices. Example input devices include: a keyboard, a mouse, a game controller, or any other suitable device for receiving action requests and communicating the action requests to the console 1415. An action request received by the I/O interface 1410 is communicated to the console 1415, which performs an action corresponding to the action request. In some embodiments, the I/O interface 1410 includes an IMU that captures calibration data indicating an estimated position of the I/O interface 1410 relative to an initial position of the I/O interface 1410. In some embodiments, the I/O interface 1410 may provide haptic feedback to the user in accordance with instructions received from the console 1415. For example, haptic feedback is provided when an action request is received, or the console 1415 communicates instructions to the I/O interface 1410 causing the I/O interface 1410 to generate haptic feedback when the console 1415 performs an action.

The console 1415 provides content to the headset 1405 for processing in accordance with information received from one or more of: the DCA 1445, the headset 1405, and the I/O interface 1410. In the example shown in FIG. 14, the console 1415 includes an application store 1455, a tracking module 1460, and an engine 1465. Some embodiments of the console 1415 have different modules or components than those described in conjunction with FIG. 14. Similarly, the functions further described below may be distributed among components of the console 1415 in a different manner than described in conjunction with FIG. 14. In some embodiments, the functionality discussed herein with respect to the console 1415 may be implemented in the headset 1405, or a remote system.

The application store 1455 stores one or more applications for execution by the console 1415. An application is a group of instructions, that when executed by a processor, generates content for presentation to the user. Content generated by an application may be in response to inputs received from the user via movement of the headset 1405 or the I/O interface 1410. Examples of applications include: gaming applications, conferencing applications, video playback applications, or other suitable applications.

The tracking module 1460 tracks movements of the headset 1405 or of the I/O interface 1410 using information from the DCA 1445, the one or more position sensors 1440, or some combination thereof. For example, the tracking module 1460 determines a position of a reference point of the headset 1405 in a mapping of a local area based on information from the headset 1405. The tracking module 1460 may also determine positions of an object or virtual object. Additionally, in some embodiments, the tracking module 1460 may use portions of data indicating a position of the headset 1405 from the position sensor 1440 as well as representations of the local area from the DCA 1445 to predict a future location of the headset 1405. The tracking module 1460 provides the estimated or predicted future position of the headset 1405 or the I/O interface 1410 to the engine 1465.

The engine 1465 executes applications and receives position information, acceleration information, velocity information, predicted future positions, or some combination thereof, of the headset 1405 from the tracking module 1460. Based on the received information, the engine 1465 determines content to provide to the headset 1405 for presentation to the user. For example, if the received information indicates that the user has looked to the left, the engine 1465 generates content for the headset 1405 that mirrors the user's movement in a virtual local area or in a local area augmenting the local area with additional content. Additionally, the engine 1465 performs an action within an application executing on the console 1415 in response to an action request received from the I/O interface 1410 and provides feedback to the user that the action was performed. The provided feedback may be visual or audible feedback via the headset 1405 or haptic feedback via the I/O interface 1410.

The network 1420 couples the headset 1405 and/or the console 1415 to the mapping server 1425. The network 1420 may include any combination of local area and/or wide area networks using both wireless and/or wired communication systems. For example, the network 1420 may include the Internet, as well as mobile telephone networks. In one embodiment, the network 1420 uses standard communications technologies and/or protocols. Hence, the network 1420 may include links using technologies such as Ethernet, 802.11, worldwide interoperability for microwave access (WiMAX), 2G/3G/4G mobile communications protocols, digital subscriber line (DSL), asynchronous transfer mode (ATM), InfiniBand, PCI Express Advanced Switching, etc. Similarly, the networking protocols used on the network 1420 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 1420 can be represented using technologies and/or formats including image data in binary form (e.g. Portable Network Graphics (PNG)), hypertext markup language (HTML), extensible markup language (XML), etc. In addition, all or some of links can be encrypted using conventional encryption technologies such as secure sockets layer (SSL), transport layer security (TLS), virtual private networks (VPNs), Internet Protocol security (IPsec), etc.

The mapping server 1425 may include a database that stores a virtual model describing a plurality of spaces, wherein one location in the virtual model corresponds to a current configuration of a local area of the headset 1405. The mapping server 1425 receives, from the headset 1405 via the network 1420, information describing at least a portion of the local area and/or location information for the local area. The user may adjust privacy settings to allow or prevent the headset 1405 from transmitting information to the mapping server 1425. The mapping server 1425 determines, based on the received information and/or location information, a location in the virtual model that is associated with the local area of the headset 1405. The mapping server 1425 determines (e.g., retrieves) one or more acoustic parameters associated with the local area, based in part on the determined location in the virtual model and any acoustic parameters associated with the determined location. The mapping server 1425 may transmit the location of the local area and any values of acoustic parameters associated with the local area to the headset 1405.

One or more components of system 1400 may contain a privacy module that stores one or more privacy settings for user data elements. The user data elements describe the user or the headset 1405. For example, the user data elements may describe a physical characteristic of the user, an action performed by the user, a location of the user of the headset 1405, a location of the headset 1405, an HRTF for the user, etc. Privacy settings (or “access settings”) for a user data element may be stored in any suitable manner, such as, for example, in association with the user data element, in an index on an authorization server, in another suitable manner, or any suitable combination thereof.

A privacy setting for a user data element specifies how the user data element (or particular information associated with the user data element) can be accessed, stored, or otherwise used (e.g., viewed, shared, modified, copied, executed, surfaced, or identified). In some embodiments, the privacy settings for a user data element may specify a “blocked list” of entities that may not access certain information associated with the user data element. The privacy settings associated with the user data element may specify any suitable granularity of permitted access or denial of access. For example, some entities may have permission to see that a specific user data element exists, some entities may have permission to view the content of the specific user data element, and some entities may have permission to modify the specific user data element. The privacy settings may allow the user to allow other entities to access or store user data elements for a finite period of time.

The privacy settings may allow a user to specify one or more geographic locations from which user data elements can be accessed. Access or denial of access to the user data elements may depend on the geographic location of an entity who is attempting to access the user data elements. For example, the user may allow access to a user data element and specify that the user data element is accessible to an entity only while the user is in a particular location. If the user leaves the particular location, the user data element may no longer be accessible to the entity. As another example, the user may specify that a user data element is accessible only to entities within a threshold distance from the user, such as another user of a headset within the same local area as the user. If the user subsequently changes location, the entity with access to the user data element may lose access, while a new group of entities may gain access as they come within the threshold distance of the user.

The system 1400 may include one or more authorization/privacy servers for enforcing privacy settings. A request from an entity for a particular user data element may identify the entity associated with the request and the user data element may be sent only to the entity if the authorization server determines that the entity is authorized to access the user data element based on the privacy settings associated with the user data element. If the requesting entity is not authorized to access the user data element, the authorization server may prevent the requested user data element from being retrieved or may prevent the requested user data element from being sent to the entity. Although this disclosure describes enforcing privacy settings in a particular manner, this disclosure contemplates enforcing privacy settings in any suitable manner.

While particular embodiments and applications have been illustrated and described, it is to be understood that the invention is not limited to the precise construction and components disclosed herein and that various modifications, changes and variations which will be apparent to those skilled in the art may be made in the arrangement, operation and details of the method and apparatus disclosed herein without departing from the spirit and scope of the present disclosure.

### ADDITIONAL CONSIDERATIONS

The foregoing description of the embodiments has been presented for illustration; it is not intended to be exhaustive or to limit the patent rights to the precise forms disclosed. Persons skilled in the relevant art can appreciate that many modifications and variations are possible considering the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

The language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments. This is done merely for convenience and to give a general sense of the disclosure. This description should be read to include one or at least one and the singular also includes the plural unless it is obvious that it is meant otherwise. Where values are described as “approximate” or “substantially” (or their derivatives), such values should be construed as accurate +/−10% unless another meaning is apparent from the context. From example, “approximately ten” should be understood to mean “in a range from nine to eleven.”

What is claimed is:

1. A display device comprising:
pixels arranged across a display area of the display device; and
a backlight unit (BLU) configured to direct light to the pixels, the BLU comprising:
one or more light sources configured to emit light; and
a planar waveguide optically coupled to receive the light emitted from the one or more light sources, the planar waveguide comprising:
a first surface facing the pixels;
a second surface facing away from the pixels; and
diffusion structures on the first surface or the second surface, a density of the diffusion structures at a first area of the planar waveguide is higher than a density of the diffusion structures at a second area of the planar waveguide closer to a center of the planar waveguide so that an intensity of light emitted from the first area is higher than an intensity of light emitted from the second area, the first area and the second area of a same distance from a light source of the one or more light sources.

2. The display device of claim 1, wherein a chief ray angle (CRA) of light emitted from the first area and received by an eye of a user aligned with the center of the planar waveguide is larger than a CRA of light emitted from the second area and received by the eye.

3. The display device of claim 1, wherein densities of the diffusion structures on the first surface or the second surface are tuned based on chief ray angles (CRAs) of light emitted from the display area and received by an eye of a user aligned with the center of the planar waveguide.

4. The display device of claim 1, wherein an eye of a user receives a first percentage of light emitted from the first area and a second percentage of light emitted from the second area, and the first percentage is less than the second percentage.

5. The display device of claim 1, wherein an eye of a user aligned with the center of the planar waveguide receives a same intensity of light from the first area as from the second area.

6. The display device of claim 1, wherein densities of the diffusion structures on the first surface or the second surface increases with distance from the center of the planar waveguide.

7. The display device of claim 1, wherein the diffusion structures have hemispherical shapes.

8. The display device of claim 1, wherein the display device is part of a head mounted display (HMD).

9. The display device of claim 1, wherein the display device is a liquid crystal display (LCD) device.

10. A head mounted display (HMD) configured to be worn on a user's head, the HMD comprising:
a body; and
a strap configured to secure the body to the user's head; and
a display device contained in the body, the display device comprising:
pixels arranged across a display area of the display device; and
a backlight unit (BLU) configured to direct light to the pixels, the BLU comprising:
one or more light sources configured to emit light; and
a planar waveguide optically coupled to receive the light emitted from the one or more light sources, the planar waveguide comprising:
a first surface facing the pixels;
a second surface facing away from the pixels; and
diffusion structures on the first surface or the second surface, a density of the diffusion structures at a first area of the planar waveguide higher than a density of the diffusion structures at a second area of the planar waveguide closer to a center of the planar waveguide so that an intensity of light emitted from the first area is higher than an intensity of light emitted from the second area, the first area and the second area of a same distance from a light source of the one or more light sources.

11. The HMD of claim 10, wherein a chief ray angle (CRA) of light emitted from the first area and received by an eye of a user aligned with the center of the planar waveguide is larger than a CRA of light emitted from the second area and received by the eye.

12. The HMD of claim 10, wherein densities of the diffusion structures are tuned based on chief ray angles (CRAs) of light emitted from the display area and received by an eye of a user aligned with the center of the planar waveguide.

13. The HMD of claim 10, wherein an eye of a user receives a first percentage of light emitted from the first area and a second percentage of light emitted from the second area, and the first percentage is less than the second percentage.

14. The HMD of claim 10, wherein an eye of a user aligned with the center of the planar waveguide receives a same intensity of light from the first area as from the second area.

15. The HMD of claim 11, wherein densities of the diffusion structures on the first surface or the second surface increases with distance from the center of the planar waveguide.

16. A method comprising:
emitting light by one or more light sources of a backlight unit (BLU) in a display device;
receiving a portion of the emitted light by a planar waveguide of the BLU, the planar waveguide comprising a first surface facing pixels of the display device and a second surface facing away from the pixels; and
directing a portion of the light in the planar waveguide towards pixels of the display device by diffusion structures on the first surface or the second surface, a density of the diffusion structures at a first area of the planar waveguide higher than a density of the diffusion structures at a second area of the planar waveguide closer to a center of the planar waveguide so that an intensity of light emitted from the first area is higher than an intensity of light emitted from the second area, the first area and the second area of a same distance from a light source of the one or more light sources.

17. The method of claim 16, wherein a chief ray angle (CRA) of light emitted from the first area and received by an eye of a user aligned with the center of the planar waveguide is larger than a CRA of light emitted from the second area and received by the eye.

18. The method of claim 16, further comprising tuning densities of the diffusion structures based on chief ray angles (CRAs) of light emitted from the display area and received by an eye of a user aligned with the center of the planar waveguide.

19. The method of claim 16, wherein an eye of a user receives a first percentage of light emitted from the first area and a second percentage of light emitted from the second area, and the first percentage is less than the second percentage.

20. The method of claim 16, wherein an eye of a user aligned with the center of the planar waveguide observes a same intensity of light from the first area as from the second area.
